(19) United States
(12) Patent Application Publication
(10) Pub. No.: US 2008/0079871 A1
(43) Pub. Date: Apr. 3, 2008

(54) LIQUID CRYSTAL DISPLAY DEVICE

(75) Inventors: Sung-Hwan HONG, Suwon-si (KR); Nam-Seok LEE, Suwon-si (KR); Sung Kyu HONG, Seongnam-si (KR); Ho-Yun BYUN, Hwaseong-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/864,321

(22) Filed: Sep. 28, 2007

(30) Foreign Application Priority Data
Sep. 29, 2006 (KR) 10-2006-0096321

(51) Int. Cl. G02F 1/1335; B32B 23/08; G02B 5/30

(52) U.S. Cl. 349/96; 156/99; 428/1.3

(57) ABSTRACT

A film unit disposed on an outer surface of a substrate includes a film and an adhesive layer provided on the film. The film is attached to the substrate through the adhesive layer, and the adhesive layer includes a first adhesive applied on a first area, and a second adhesive applied on a second area and having a different adhering force from the first adhesive. The first area and the second area are symmetrically disposed about a central part of the film.

### CROSS-REFERENCE TO RELATED APPLICATIONS

This application claims priority from and the benefit of Korean Patent Application No. 10-2006-0096321, filed Sep. 29, 2006, which is hereby incorporated by reference for all purposes as if fully set forth herein.

### BACKGROUND OF INVENTION

1. Field of Invention

The present invention relates to a liquid crystal display device that may have improved image quality.

2. Discussion of the Background

Recently, the widely used Braun tube display device has been gradually replaced by flat panel display devices. A liquid crystal display device, which is one of the more popular flat panel displays, includes two glass substrates formed with electrodes and a liquid crystal layer disposed therebetween. The liquid crystal display device supplies voltage to the electrodes, thereby rearranging the liquid crystal molecules of the liquid crystal layer to control the amount of transmitted light. Since a liquid crystal display panel is not self-emissive, it uses light supplied by a backlight unit. The light supplied from the backlight unit passes through a polarizing plate before being transmitted to the liquid crystal layer. The polarizing plate allows only light oscillating parallel to a transmission axis to pass so that polarized light enters the liquid crystal layer.

Generally, the polarizing plate includes a tri acetate cellulose (TAC) film layer employed for a supporting body to improve durability of the polarizing plate, a poly vinyl alcohol (PVA) film layer including a dichroism pigment absorbing the polarized light and employed for a substantial polarizer, a protecting film layer, and an adhesive layer. The PVA film layer is elongated to enhance polarization of the polarizing plate, and a dyeing exhaustion arrangement of the dichroism pigment of the PVA film layer is determined depending on elongation so that the polarization can be determined. However, as elongation strength increases, a contraction stress applied to the PVA film layer increases. Here, since the PVA film layer and the adhesive layer may have different contraction coefficients, an optical axis and a retardation value may change, and an inferiority such as a stain may be caused, which deteriorates image display quality.

FIG. 1 illustrates a butterfly stain as an example of one of the stain inferiorities.

### SUMMARY OF THE INVENTION

The present invention provides a polarizing plate, a liquid crystal display device and a manufacturing method thereof that may improve image display quality.

Additional aspects of the present invention will be set forth in part in the description which follows and, in part, will be obvious from the description, or may be learned by practice of the present invention.

The present invention discloses a film unit disposed on an outer surface of a substrate. The film unit includes a film and an adhesive layer on the film. The film is attached to the substrate through the adhesive layer, and the adhesive layer includes a first adhesive on a first area, and a second adhesive on a second area. The second adhesive has a different adhering force than the first adhesive, and the first area and the second area are symmetrically disposed about a central part of the film.

The present invention also discloses a liquid crystal display panel that includes two substrates, a liquid crystal layer interposed between the substrates, and a polarizing plate attached to an outer surface of each substrate. The polarizing plate includes a film and an adhesive layer on the film. The adhesive layer includes a first adhesive on a first area, and a second adhesive on a second area. The second adhesive has a smaller adhering force than the first adhesive. The first area includes a central part of the polarizing plate and two edge parts of the polarizing plate which are symmetrical with respect to an absorption axis direction of the polarizing plate, and the second area includes two remaining edge parts of the polarizing plate.

The present invention also discloses a liquid crystal display device including a liquid crystal display panel, a backlight assembly, and a container accommodating the liquid crystal display panel and the backlight assembly. The liquid crystal display panel includes two substrates, a liquid crystal layer interposed between the substrates, and a polarizing plate attached to an outer surface of each substrate. The polarizing plate includes a film and an adhesive layer on the film. The adhesive layer includes a first adhesive on a first area, and a second adhesive on a second area. The second adhesive has a different adhering force than the first adhesive. The first area and the second area are divided into two sub areas, and a total area of the first area and a total area of the second area are substantially the same.

The present invention also discloses a method for manufacturing a polarizing plate for a liquid crystal display device. The polarizing plate includes a film and an adhesive layer. The film includes a protecting film layer, two tri acetate cellulose film layers disposed between the protecting film layer and the adhesive layer, and a poly vinyl alcohol film layer disposed between the two tri acetate cellulose film layers. The manufacturing method includes putting together a tri acetate cellulose film and a poly vinyl alcohol film, putting together the put tri acetate cellulose film and poly vinyl alcohol film and the protecting film, and applying an adhesive to a release film, and putting together the release film applied with the adhesive and the film. The stage of applying the adhesive to the release film includes using an ink jet apparatus including at least two nozzles which respectively jet an adhesive having a different adhering force and applying the adhesive having the different adhering force to the release film by varying the position of the nozzles when the adhesive is jetted.

The present invention also discloses a method for manufacturing a polarizing plate for a liquid crystal display device. The polarizing plate includes a film having an absorption axis and a transmission axis, and an adhesive layer. The manufacturing method includes coating an adhesive to a release film, and putting together the release film coated with the adhesive and the film. The stage of coating the adhesive to the release film includes applying an adhesive having a ultraviolet curable material or a thermal curable material to the release film, supplying an ultraviolet radiation or heat to the adhesive on the release film, and putting together the release film and the film. The ultraviolet radiation or heat supplying stage includes using a chamber which provides a mask disposed above the release film and formed with a pattern, and supplying an ultraviolet radiation or heat to the adhesive on the release film through the mask to form a pattern of the adhesive.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a butterfly stain caused by contraction of a polarizing film.

FIG. 2A, FIG. 2B, FIG. 2C and FIG. 2D are views showing a film unit and a substrate according to a first exemplary embodiment of the present invention.

FIG. 3 is an exploded perspective view showing a liquid crystal display panel according to a second exemplary embodiment of the present invention.

FIG. 4 is an exploded perspective view showing a liquid crystal display panel according to a third exemplary embodiment of the present invention.

FIG. 5 shows a method for manufacturing a polarizing plate according to a fourth exemplary embodiment of the present invention.

FIG. 6 shows a method for manufacturing a polarizing plate according to a fifth exemplary embodiment of the present invention.

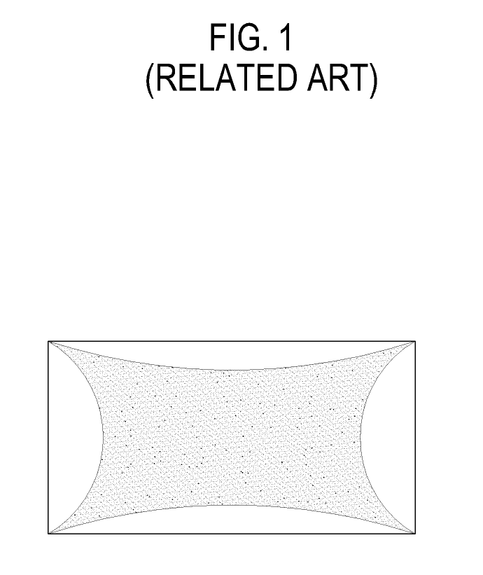

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

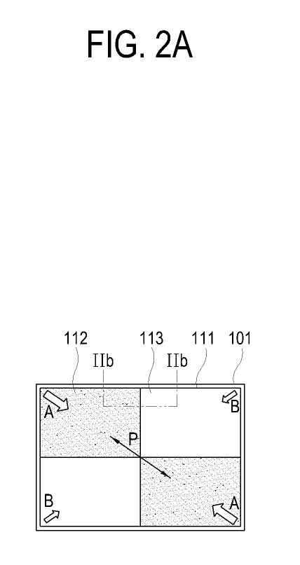

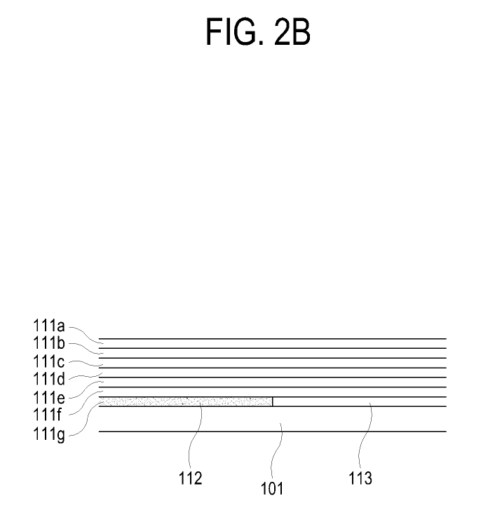

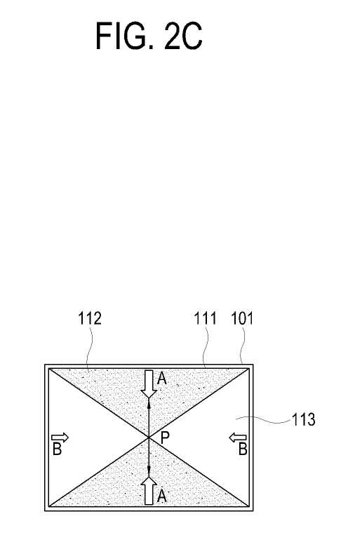

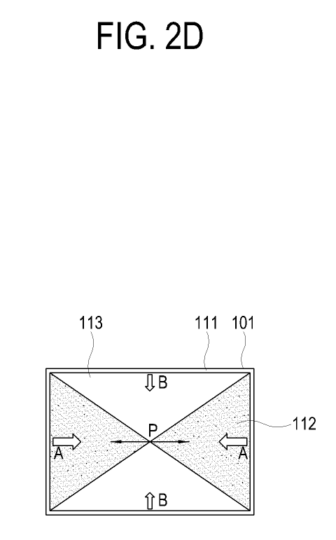

FIG. 2A, FIG. 2B, FIG. 2C and FIG. 2D show a film unit 111 and a substrate 101 according to a first exemplary embodiment of the present invention. Referring to FIG. 2A, FIG. 2B, FIG. 2C and FIG. 2D, P shows a direction of an absorption axis of each film unit 111, and arrows A and B refer to directions of contraction stresses that the film units 111 receive in respective positions. Arrow A refers to a relatively high contraction stress, and arrow B refers to a relatively small contraction stress. Polarization is determined by elongation of film layers in which dichroism pigment of the film unit is arranged. Here, since an elongation direction is the same as the direction of the absorption axis P, a contraction stress is highest in the same direction as the absorption axis P, as shown in FIG. 2A, FIG. 2C, and FIG. 2D. The substrate 101 may be a substrate such as a thin film transistor substrate or a common electrode substrate.

Referring to FIG. 2A and FIG. 2B, the film unit 111 comprises a pair of protecting film layer 111a and 111f, a pair of tri acetate cellulose (TAC) film layer 111b and 111d, a poly vinyl alcohol (PVA) film layer 111c, a compensating film 111e and an adhesive layer 111g. the PVA film layer 111c is disposed between the pair of TAC film layer 111b and 111d. Although not shown, a film unit and a polarizing plate to be described may have similar structure as shown in FIG. 2A and FIG. 2B.

In other embodiments, the position of the compensating film 111e may be changed in various ways. Further, the compensating film 111e may be omitted.

The absorption axis P is arranged in a diagonal direction of the film unit 111. Referring to arrows A and B representing the intensity of stress, two edge parts positioned in dark areas receive a relatively high contraction stress, and two edge parts positioned in bright areas receive a relatively small contraction stress. If an adhesive layer 111g applied to the film unit 111 has the same adhering force all over the surface of the film unit 111, since the two edge parts that receive the relatively high contraction stress A would contract more than the other parts, the absorption axis P deviates to deteriorate light property. This problem may become more pronounced as the size of a substrate increases because the amount of contraction increases. However, as shown in FIG. 2A, if a first adhesive, which has a relatively high adhering force, is applied to two dark areas 112, and a second adhesive, which has a relatively small adhering force, is applied to two bright areas 113, the adhering force of the first adhesive corresponds to the contraction stress of the film unit 111 to reduce the amount of contraction of the film unit 111 and relieve the deviation of the absorption axis P. That is, by dividing the adhesive layer 111g of the film unit 111 into four rectangular areas that are symmetrically disposed about the center of the film unit 111, and applying an adhesive having a relatively high adhering force to two areas symmetrical about an axis along an inclined direction of the absorption axis P, deterioration depending on a contraction stress difference of the film unit 111 may be reduced.

Referring to FIG. 2C, the absorption axis P is arranged in a vertical direction of the film unit 111. Here, central parts of upper and lower edges about a point at which two diagonal lines of the film unit 111 meet, that is, two parts to which the contraction stress of A is applied receive a greater contraction stress than the other parts. If the adhesive layer has the same adhering force all over the surface of the film unit 111, the absorption axis P deviates due to a stress difference between a side part receiving a small contraction stress, that is, two parts to which the contraction stress of B is applied, and the parts to which the contraction stress of A is applied. However, as described above with reference to FIG. 2A, if a first adhesive having a relatively larger adhering force is applied to two dark areas 112, and a second adhesive having a relatively smaller adhering force is applied to two bright areas 113, the amount of the contraction stress of the film unit 111 can be reduced, thereby relieving deviation of the absorption axis P.

FIG. 2D shows a first adhesive applied area 112 and a second adhesive applied area 113 for preventing the absorption axis P from deviating if the absorption axis P is arranged a horizontal direction of the film unit 111.

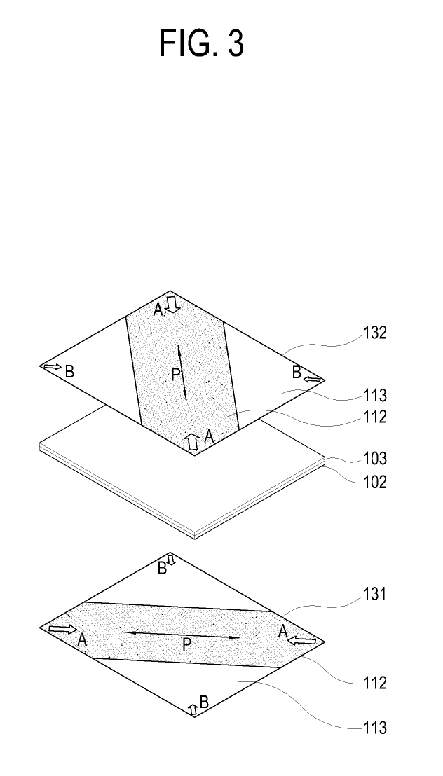

FIG. 3 is an exploded perspective view showing a liquid crystal display panel according to a second exemplary embodiment of the present invention. Referring to FIG. 3, a liquid crystal display panel according to a second exemplary embodiment of the present invention includes a thin film transistor substrate 102, a color filter substrate 103, a liquid crystal layer (not shown) interposed between the substrates, and two polarizing plates attached to the liquid crystal display panel. Specifically, a first polarizing plate 131 is attached to a lower part of the thin film transistor substrate 102, and a second polarizing plate 132 is attached to an upper part of the color filter substrate 103. Driving parts of both substrates and the liquid crystal layer may employ various configurations, and absorption axes P of both substrates may perpendicularly cross or be in parallel with each other depending on a liquid crystal mode. The absorption axes P of the first polarizing plate 131 and the second polarizing plate 132 are arranged in substantially the same direction as a diagonal line of the polarizing plates 131 and 132, respectively. The direction of the diagonal line and the direction of the absorption axis P may minutely deviate according to a manufacturing condition. The angle between the diagonal line and the absorption axis may be generally managed to be less than 5 degrees. Here, as described above with reference to FIG. 2A, two facing edge parts along the absorption axis P may receive a high contraction stress so that the absorption axis P can deviate. As shown therein, if a first adhesive having a high adhering force is applied to an area 112 connecting two facing edge parts along an absorption axis P direction and a central part and a second adhesive having a small adhering force is applied to the remaining area, the amount of contraction of an area receiving a high contraction stress can be reduced, thereby relieving deviation of the absorption axis P.

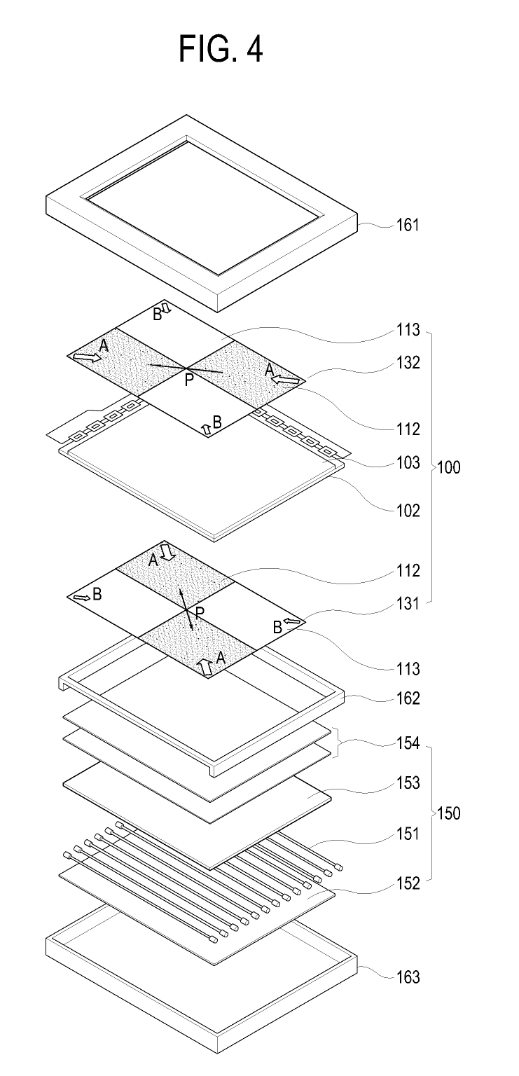

FIG. 4 is an exploded perspective view showing a liquid crystal display device according to a third exemplary embodiment of the present invention. Referring to FIG. 4, a liquid crystal display device according to a third exemplary embodiment of the present invention includes a backlight unit 150 including a lamp 151, a reflecting plate 152, a light guide plate 153, and an optical sheet part 154; a liquid crystal display panel 100 including a thin film transistor substrate 102, a color filter substrate 103, a liquid crystal layer (not shown), a first polarizing plate 131, and a second polarizing plate 132; an upper container 161; a mold frame 162; and a lower container 163. Light emitted from the lamp 151 may be directly transmitted to the light guide plate 153 or be reflected by the reflecting plate 152 to be transmitted to the light guide plate 153. The light guide plate 153 and the optical sheet part 154 diffuse and collect light transmitted through the lamp 151 or the reflecting plate 152 to be transmitted to the liquid crystal display panel 100. The backlight unit 150 is shown as a direct backlight unit having a plurality of lamps, however, various configurations may be applied thereto according to a property of product to be manufactured. Light transmitted from the backlight unit 150 proceeds through the first polarizing plate 131, the thin film transistor substrate 102, the liquid crystal layer, the color filter substrate 103, and the second polarizing plate 132 in order, to thereby complete a desired image. Various configurations may be applied to a driving part and the liquid crystal layer of the liquid crystal display panel 100, and absorption axes P of the first and second polarizing plates 131 and 132 may be disposed to perpendicularly cross or be in parallel with each other depending on a liquid crystal mode. Here, the absorption axis P is arranged in a diagonal direction of the respective polarizing plates 131 and 132. Since two edge parts receiving a relatively high contraction stress of A are contracted more than other parts, a first adhesive having a relatively high adhering force is applied to two dark areas 112 of FIG. 4, and a second adhesive having an adhering force that is smaller than the first adhesive is applied to two bright areas 113. The high adhering force of the first adhesive counteracts contraction stress of a film unit 111 to reduce the amount of contraction of the film unit 111. Relation between the direction of the absorption axis P of the first polarizing plate 131 and the second polarizing plate 132, and the first adhesive applied area 112 and the second adhesive applied area 113 is irrelevant to position of the polarizing plate in the liquid crystal display panel, and is determined by the direction of the absorption axis P.

If a phase difference compensating film is provided to the film unit according to the present exemplary embodiment, a liquid crystal display device having a wide viewing angle can be manufactured, and the phase difference compensating film may have various configurations according to a property of the liquid crystal display panel. The phase difference compensating film compensates birefringence of the liquid crystal and include ½λ plate and ¼λ plate.

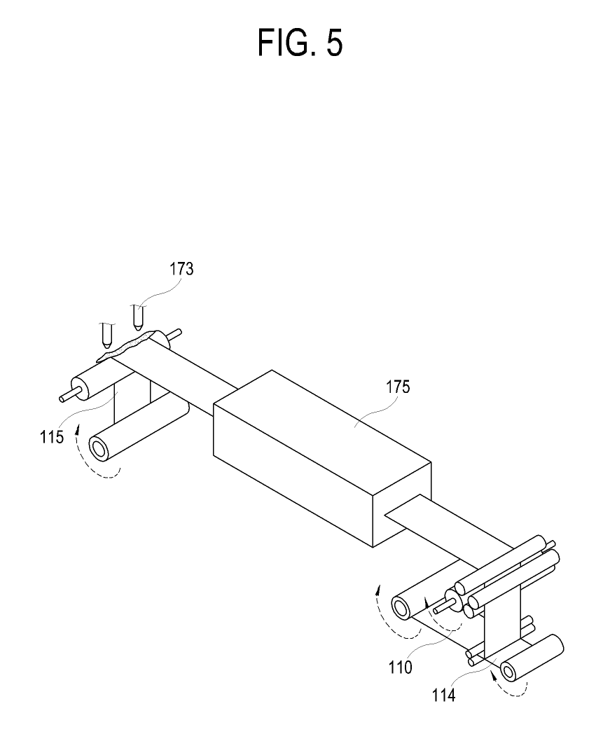

FIG. 5 shows a method for manufacturing a polarizing plate according to a fourth exemplary embodiment of the present invention. A poly vinyl alcohol (PVA) film layer and a tri acetate cellulose (TAC) film layer may be formed to a protecting film by using a known method or any other suitable method. For example, before an adhesive applying process, a manufacturing method of a polarizing plate may include a pretreatment process including an etching process to convert the surface of the TAC film to be hydrophilic, a washing and drying process, and an elongating and laminating process to attach the TAC film to the PVA film after dyeing exhaustion, elongation, complementary color, and dry. As shown in FIG. 5, a method for forming an adhesive layer including an area having a different adhering force to a film 114 manufactured by the processes described above includes an applying and drying stage of an adhesive to a release film 115, and an attaching stage of attaching the release film 115 having the adhesive layer, and the film 114 including a PVA film layer, a TAC film layer, and a protecting film layer, which are manufactured in advance. The adhesive may be applied to the release film 115 using an ink jet apparatus including a plurality of nozzles 173, which jet adhesives having different adhering forces. That is, the plurality of nozzles 173 are positioned above the release film 115, and the nozzles 173 apply adhesives having different adhering forces by each nozzle while moving left and right or forward, backward, left, and right according to an adhesive pattern to be manufactured. The drying of the adhesive is performed in a dry chamber 175.

A film complex 110 comprises the film 114, the release film 115 and adhesive layer formed therebetween. The film complex 110 is cut to predetermined size and attached to the substrate. The release film 115 is removed from the film complex 110 before or during attaching to the substrate.

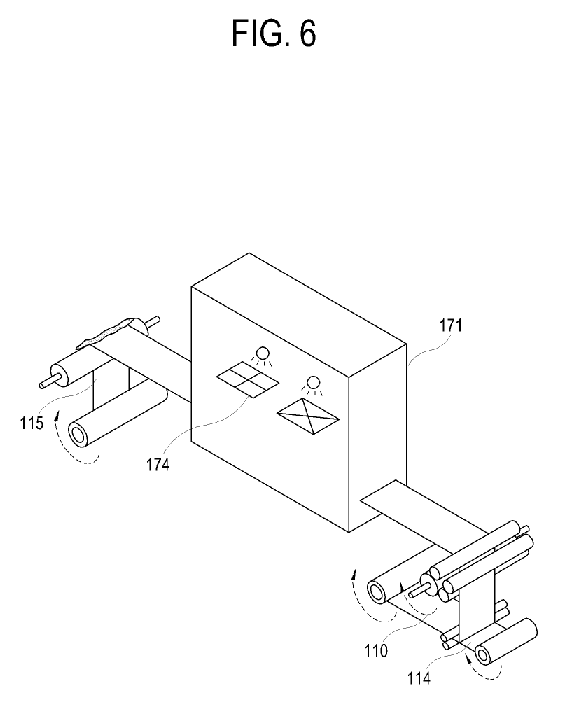

FIG. 6 shows a method for manufacturing a polarizing plate according to a fifth exemplary embodiment of the present invention. An attaching method of a film 114 combined by a PVA film layer, a TAC film layer, and a protecting film layer, which are manufactured in advance, to a release film 115 having an adhesive may employ the same method as in the fourth exemplary embodiment. As shown in FIG. 6, a method for applying an adhesive having areas of different adhering forces to a release film 115 comprises an applying stage of an adhesive comprising a ultraviolet (UV) radiation curable material or a thermal curable material, and a supplying stage of UV radiation or heat to the applied adhesive through a mask 174 formed with an adhesive pattern to be manufactured. The adhesive may be a thermosetting material containing a photopolymerization initiator or a thermal initiator, and its adhering force may vary according to the amount of supplied UV radiation or heat. For example, the adhesive may be made of material including an acryl series, an alkenyl series, or an epoxy series containing the photopolymerization initiator or the thermal initiator. The curing of the adhesive is performed in a curing chamber 171. As described above, the present invention provides a polarizing plate, a liquid crystal display device and a manufacturing method thereof minimizing effect of contraction stress against a film adhering to a substrate, thereby improving image display quality.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A film unit disposed on an outer surface of a substrate, comprising:
a film; and
an adhesive layer on the film,
the film being attached to the substrate through the adhesive layer,
the adhesive layer comprising a first adhesive on a first area, and a second adhesive on a second area and having a different adhering force than the first adhesive, and
the first area and the second area being symmetrically disposed about a central part of the film.

2. The film unit of claim 1, wherein the first area and the second area each comprise a plurality of sub areas.

3. The film unit of claim 2, wherein the first area and the second area each comprise two rectangular-shaped sub areas, and one sub area of the first area is adjacent to two sub areas of the second area.

4. The film unit of claim 2, wherein the first area and the second area each comprise two isosceles triangle-shaped sub areas, and one sub area of the first area is adjacent to two sub areas of the second area.

5. The film unit of claim 1, wherein the film comprises a protecting film layer, a tri acetate cellulose (TAC) film layer, and a poly vinyl alcohol (PVA) film layer.

6. The film unit of claim 5, wherein the TAC film layer is provided as a pair and disposed between the protecting film layer and the adhesive layer, and the PVA film layer is disposed between the pair of TAC film layers.

7. The film unit of claim 1, wherein the film unit comprises an absorption axis to absorb light, and a transmission axis to transmit light.

8. The film unit of claim 7, wherein the first adhesive has a greater adhering force than the second adhesive, and
at least one absorption axis of the film unit passes through the first area.

9. The film unit of claim 1, wherein the first adhesive and the second adhesive comprise an acryl series ingredient, an alkenyl series ingredient, or an epoxy series ingredient.

10. The film unit of claim 1, further comprising a compensating film.

11. A liquid crystal display panel, comprising:
a first substrate and a second substrate;
a liquid crystal layer interposed between the first substrate and the second substrate; and
a polarizing plate attached to an outer surface of each of the first substrate and the second substrate,
the polarizing plate comprising a film and an adhesive layer on the film,
the adhesive layer comprising a first adhesive on a first area, and a second adhesive on a second area and having a smaller adhering force than the first adhesive, and
the first area comprising a central part of the polarizing plate and two edge parts of the polarizing plate which are symmetrical with respect to an absorption axis direction of the polarizing plate, and the second area comprising two remaining edge parts of the polarizing plate.

12. The liquid crystal display panel of claim 11, wherein an angle between a direction of a line which links the two edge parts of the polarizing plate that are disposed in the first area and the absorption axis direction of the polarizing plate is less than 5 degrees.

13. The liquid crystal display panel of claim 11, wherein the first adhesive and the second adhesive comprise an acryl series ingredient, an alkenyl series ingredient, or an epoxy series ingredient.

14. The liquid crystal display panel of claim 11, wherein the polarizing plate further comprises a compensating film.

15. A liquid crystal display device, comprising:
a liquid crystal display panel;
a backlight assembly; and
a container accommodating the liquid crystal display panel and the backlight assembly,
the liquid crystal display panel comprising:
a first substrate and a second substrate;
a liquid crystal layer interposed between the first substrate and the second substrate; and
a polarizing plate attached to an outer surface of each of the first substrate and the second substrate,
the polarizing plate comprising:
a film; and
an adhesive layer on the film,
the adhesive layer comprising a first adhesive on a first area, and a second adhesive on a second area and having a different adhering force than the first adhesive,
the first area and the second area each comprising two sub areas, and
a total area of the first area and a total area of the second area being substantially the same.

16. The liquid crystal display device of claim 15, wherein the two sub areas of the first area are symmetrically disposed with respect to a central part of the film, and
the two sub areas of the second area are symmetrically disposed with respect to the central part of the film.

17. The liquid crystal display device of claim 15, wherein the first adhesive has a greater adhering force than the second adhesive, and
at least one absorption axis of the polarizing plate passes through the first area.

18. The liquid crystal display device of claim 15, wherein the polarizing plate further comprises a compensating film.

19. A method for manufacturing a polarizing plate for a liquid crystal display device, the polarizing plate comprising a film and an adhesive layer, the film comprising a protecting film layer, two tri acetate cellulose film layers disposed between the protecting film layer and the adhesive layer, and a poly vinyl alcohol film layer disposed between the two tri acetate cellulose film layers, the method comprising:
putting together a tri acetate cellulose film and a poly vinyl alcohol film;
putting together the tri acetate cellulose film and the poly vinyl alcohol film and the protecting film; and
applying an adhesive to a release film, and putting together the release film having the adhesive and the film,
wherein applying the adhesive to the release film comprises:
using an ink jet apparatus comprising at least two nozzles which respectively supply an adhesive having a different adhering force, and
applying the adhesive having the different adhering force to the release film by varying the position of the nozzles.

20. A method for manufacturing a polarizing plate for a liquid crystal display device, the polarizing plate comprising a film having an absorption axis and a transmission axis, and an adhesive layer, the manufacturing method comprising:
disposing an adhesive on a release film; and
putting together the release film having the adhesive and the film,
wherein disposing the adhesive on the release film comprises:
disposing an adhesive comprising a ultraviolet radiation curable material or a thermal curable material on the release film;
supplying an ultraviolet radiation or heat to the adhesive on the release film; and
putting together the release film and the film,
wherein the ultraviolet radiation or heat supplying stage comprises:
using a chamber which provides a mask disposed above the release film and formed with a pattern and which supplies the ultraviolet radiation or heat to the adhesive applied on the release film through the mask to form a pattern of the adhesive.

21. The method of claim 20, wherein the adhesive comprises a photo initiator or a thermal initiator.

22. The method of claim 20, wherein the adhesive comprises an acryl series ingredient, an alkenyl series ingredient, or an epoxy series ingredient.
